(19) United States
(12) Patent Application Publication
(10) Pub. No.: US 2008/0173831 A1
(43) Pub. Date: Jul. 24, 2008

(54) Optoelectronic sensor and method for detecting objects in a monitored region

(75) Inventor: Martin Wuestefeld, Sexau (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch (DE)

(21) Appl. No.: 12/009,523

(22) Filed: Jan. 17, 2008

(30) Foreign Application Priority Data
Jan. 20, 2007 (DE) 10 2007 003 026.8

(51) Int. Cl. G02B 27/00

(52) U.S. Cl. 250/551

(57) ABSTRACT

An optoelectronic sensor for detecting objects in a monitored region which has light emitters and associated light receivers adjustably arranged relative to each other so that light emitted by the light emitter is directly received by the light receiver. The light emitter and the light receiver conform to normed requirements which define a normed region that is free of reflecting surfaces so that light emitted by the light emitter which passed beyond the normed region cannot be received by the light receiver due to a reflection of such light. In the normed region, an emitted light cone generated by the light emitter and a received light cone defined by the light receiver overlap within a normed opening angle. An evaluation unit interprets the interruption in the light directed to the light receiving element as a detection of an object in the monitored region. The light emitter forms an emitted light cone with an opening angle of any desired magnitude, while the light receiver has a received light cone with an opening angle of no more than one-half of the normed opening angle.

### CROSS-REFERENCES TO RELATED APPLICATIONS

This application claims the priority of German Patent Application No. 10 2007 003 026.8, filed Jan. 20, 2007, the disclosure of which is incorporated herein by reference.

### BACKGROUND OF THE INVENTION

The present invention concerns an optoelectronic sensor and a method for detecting objects in a monitored region.

Sensors, and especially light grids, are used to protect dangerous areas against entries by persons or objects. As an example, if the machine is a press brake, its operation may have to be instantaneously stopped when persons come too close to it. The light grid forms a virtual wall which generates a warning or a shut-off signal when the virtual wall is “touched”.

For this, a number of light emitters are used which direct their light beam onto opposing light receivers. A set of spaced-apart light beams is generated, and their spacing from each other determines the minimum object size for reliably detecting it. Usually non-visible light, such as infrared light, is used. However, light of almost any desired wave length can be used.

To detect an interruption of the light beam, the light from the light emitter must be received by the associated light receiver. Safety norms or standards, such as the IEC 61496-2 norm, require that the light receiver may not unintentionally receive light other than on a direct path from the light emitter. For example, light reaching the receiver might have been reflected by a reflecting surface located outside the region monitored by the light grid. If the opening angles of the light emitter and the light receiver do not make sure that only directly received light is detected, the presence of an object in the monitored region might be overlooked.

Aperture stops are typically placed at the focal points of the emitting and receiving optics. This assures that the light emitting angle of the light emitter is small and that, in spite of the correspondingly small sight angle of the light receiver, the latter is positioned and oriented so that it receives light from the associated light emitter. The angles specified by the norms dictate the design of the sensor. A disadvantage is that the light receiver and light emitter must be precisely aligned. In addition, mechanical components such as aperture stops as well as optics are required for the emitter and the receiver.

The emitting unit and the receiving unit typically have a housing holding a number of light emitters and light receivers. The units are arranged at both ends of the light grid and oppose each other. Due to the small opening angles, the emitting unit and receiving units must be spatially precisely aligned with respect to each other.

The needed adjustment becomes more difficult when infrared light is used because it is not visible.

EP 0 889 332 A1 discloses to use an additional, collimated and visible laser beam for alignment assistance. The visible light dot of the laser can be directed onto a predetermined target point to determine the spatial position of the emitting and receiving units with respect to each other. However, this involves additional costs because an additional laser must be built into the unit. This laser must further be precisely oriented relative to the light emitters. Finally, the laser dot must initially be captured on the receiving unit before it can be of any assistance in the adjustment procedure, which, depending on the prevailing conditions, might be difficult.

It is also known to measure the signal strengths of the associated light emitter/receiver pairs and to display them. The alignment is correct when the intensity distribution decreases towards the periphery of the receiver. Here too, at least a portion of the light beam must initially hit the receiver unit before a useful display becomes possible. Signal processing for this technique is complicated and is required for each beam. Depending on the optical system configuration, the signal magnitudes may not be a useful measurement for the accuracy of the alignment.

EP 0 875 873 B1 seeks to help prevent light reflections and proposes to use a position resolving light receiver. A desired position for the received light on the light receiver is established during a learning phase of the sensor. In use, when the position of the received light strays too far from the desired position, the sensor is activated because it is presumed that the encountered offset in the received light could not have been received directly, but must have been received via reflection, and that the direct light path is blocked by an object. This renders the sensor safe against interference from and false reading caused by reflected light. However, it is of no help for adjusting the position of the light emitter relative to the light receiver, because a desired position can only be determined when light is received on the position resolving receiver in the first place. Due to the small opening angle of the light emitter, this can only occur after an initial, correspondingly precise adjustment, for which EP 0 875 873 B1 provides no help or assistance.

### BRIEF SUMMARY OF THE INVENTION

It is therefore an object of the present invention to provide an optical sensor which is of a simplified construction and readily aligned while it reliably prevents interference from reflected light.

Such a sensor has at least one light emitter and one associated light receiver which are arranged with respect to each other so that the receiver receives the light from the emitter directly. The light emitter is within a normed region which is free of reflecting surfaces, as required by the conditions of the norm or standard (hereafter usually “normal conditions”). The sensor prevents emitted light that passed beyond the normed region from being received by the light receiver due to light reflected from outside the normed region (hereafter “retro-reflected” or “retro-reflections”). An overlap of an emitted light cone from the emitter and a received light cone of the receiver includes the normed opening angle. An evaluation unit interprets an interruption in the light directed to the light receiver as a detection of an object in the monitored region. The light emitter forms an emitted light cone with an opening angle of any desired magnitude, while the light receiver is configured to limit an opening angle of the received light cone to no more than one-half the normed opening angle.

The solution provided by the present invention has the advantage that light reflections by reflecting surfaces which have a predetermined minimum spacing from the sensor, which is permitted by the safety norms, are still acceptable even though the sending side of the sensor is significantly lighter and can be more quickly aligned than a sensor that directly fulfills the conditions for the normed opening angle.

On the sending side of the sensor, no mechanical aperture stops or focusing optics are required. Due to the large emitted light cone, there are almost no tolerances that must be maintained, and necessary mounting surfaces, such as a lens holder or a holder for a tubular member that protects against stray light, can be entirely omitted. This significantly reduces the manufacturing costs of the light emitter. Since no optomechanical components are needed, the light emitter can simply be a light diode with the necessary electronics arranged in a housing. This makes the sending side of the sensor especially small.

The basis for the present invention is the realization that it is not necessary to limit the light cone at both the sending side and the receiving side of the sensor. The present invention recognizes that security against retro-reflection (“retro-reflection security”) required by the normed opening angles for the light emitter as well as the light receiver can be attained by more strictly controlling the opening angle of only the light receiver. The compensation factor for smaller opening angles is two, so that half of the normed opening angle, or a smaller angle, must be selected. In this manner, the safety norm is satisfied with an exceedingly simple light emitter that itself needs no adjustments. The conventional first step in properly adjusting and aligning the sensor, that is, aligning the sensor relative to the receiver, is completely eliminated by the present invention.

The light receiver is preferably position resolving. The evaluation unit is configured to determine the desired light receiving position on the light receiver and treats the receipt of light outside the desired light receiving position as a detection of an object in the monitored region. The position resolving light receiver is conventionally used for the second adjustment and alignment step in which the light receiver is aligned relative to the light emitter. In accordance with the invention, this is the only alignment step that is necessary, and it has been significantly simplified and the desired position on the receiver where the light should strike it can frequently be learned by the receiver during a learning phase, so that the user need not make any adjustments himself. The more strict opening angle that at most may only be one-half of the normed opening angle can be set in a much simplified alignment procedure. The additional cost of a position resolving receiver is overcompensated for by the savings made possible by the present invention.

The light emitter can be provided with optics for reducing the width of the emitted light cone to increase the reach or range of the sensor. This smaller emitted light cone is still independent of the normed opening angle. Focusing only serves to provide the light receiver with a higher intensity of the incoming light. Depending on the range of the sensor, a lens cup or reflectors on the light emitter are sufficient to attain the needed beam intensity. Such light emitters are commercially available as finished components.

In another embodiment of the invention, a multiplicity of light emitters are arranged on a flexible carrier, preferably a hose. The flexible carrier can be mounted on protruding surfaces, or it can be integrated into ergonomically shaped surfaces. Thus, the sensor need not be mounted on right-angled structures and, instead, can be fitted to surfaces of almost any shape. This renders the protected field adjustable and facilitates the installation of the sensor in a greater number of applications where the monitoring of a space is needed.

The present invention also provides for arranging a multiplicity of light receivers on a flexible carrier, preferably a hose, with each receiving optics being immovably fixed relative to its associated light receiver. In such a case, the already mentioned advantages for the light emitter can also be realized for the light receiver. Due to the fixed connection of the receiving optics relative to the associated light emitter, a received light cone with at most one-half the normed opening angle is maintained. A changed orientation of the light emitter relative to the light receiver caused by the flexible carrier can to a large extent be compensated for by having the light receiver learn the desired position during a learning phase.

It is even more preferred to use a flexible carrier and the evaluation unit that permits severing a portion of the flexible light receiver and/or light emitter carrier for varying the height of the protected field. In addition, the sensor can be fitted to the spatial conditions at the place of installation. The user can always make use of the same universal hose and fit it to the encountered conditions without further effort. This allows the user to limit the needed inventory of parts with which sensor variations can be assembled.

The light emitters and/or light receivers are preferably electrically connected in series so that they can be operated with a common current supply and evaluation unit. When a portion of the light receiver/light emitter is severed, the connection to the remaining elements remains operative.

The sensor is preferably a light barrier or a light grid. Such sensor types are frequently employed for securing purposes where retro-reflection security and a simple adjustability are important.

In a further development of a light grid, a multiplicity of light emitters and light receivers are installed in two housings so that in use a light emitter is always opposite the associated light receiver. Light emitters and light receivers can therefore be installed in both housings; it is not necessary that the light emitters oppose the light receivers as a homogeneous group as long as all the respective pairs are associated with each other. This provides more options for the different monitoring arrangement.

In another embodiment of the invention, the light emitters have their own supply and control units, and the latter is configured so that it optically synchronizes itself with the evaluation unit of the light receiver. In this case, the light emitter is independent and can be individually mounted.

In a further alternative, the light emitter and light receiver with the evaluation unit are connected to a common current supply, while the evaluation unit is configured to optically and/or electronically synchronize the light emitter and light receiver. Depending on the particular installation, either an optical or an electronic synchronization might be preferred.

The method of the present invention makes use of the above-discussed features of the present invention.

### BRIEF DESCRIPTION OF THE DRAWINGS

FIG. 1 is a side elevational view of a preferred embodiment of the invention and illustrates different opening angles;

FIG. 2a is a plan view of a light emitter-light receiver pair and is used for explaining the manner in which the present invention complies with light retro-reflection conditions;

FIG. 2b is a plan view of a light emitter and light receiver pair and is used to compare and demonstrate that the light retro-reflection conditions of the present invention meet the requirements of light retro-reflection conditions set by the norm and/or required by the prior art;

FIG. 2c schematically illustrates normed conditions for retro-reflection security;

FIG. 3 three-dimensionally illustrates the learning phase for establishing the desired light receiving position on the light receiver;

FIG. 4 is a plan view of the illustration in FIG. 3; and

FIG. 5 shows a second embodiment of the invention in which the light emitters are arranged on a flexible carrier.

### DETAILED DESCRIPTION OF THE PREFERRED EMBODIMENTS

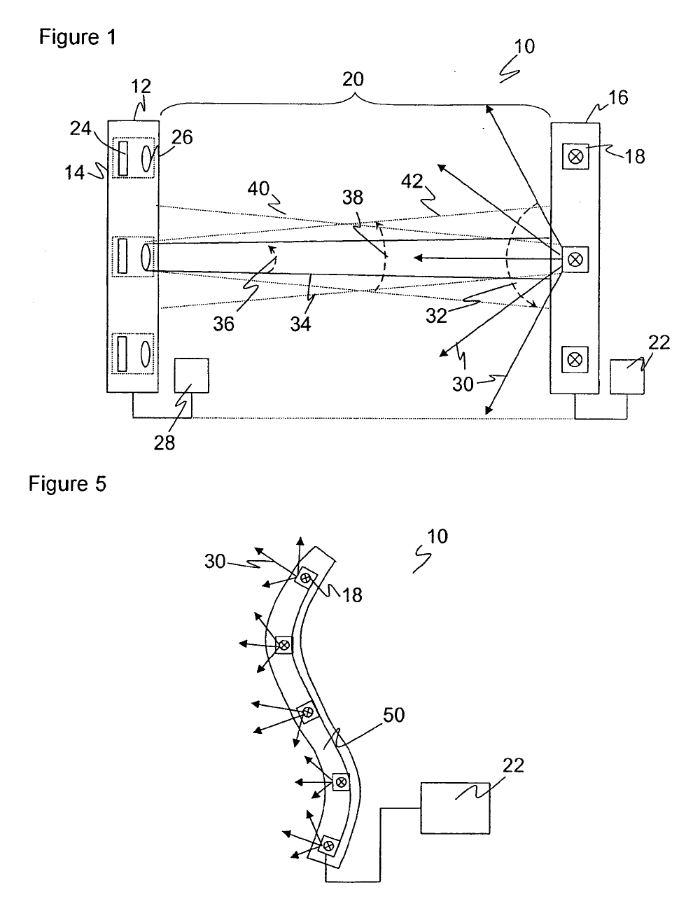

FIG. 1 shows a first embodiment of a sensor 10 constructed in accordance with the present invention. Sensor 10 has a reception housing 12 with light receivers 14 and an emitter housing 16 with light emitters 18. Typically all light emitters are arranged in one housing 16, and all light receivers in another housing 12, to limit the number of needed different parts. However, this is not mandatory. For example, some light emitters 18 and some light receivers 14 can be arranged in each housing 12, 16, so long as the light receivers 18 are paired with associated light receivers 14.

A monitored region 20 is located between receiver housing 12 and emitter housing 16. Objects entering the monitored region are detected by sensor 10 because they interrupt the direct light path from light emitters 18 to light receivers 14. The distance between adjacent light emitters 18 and light emitters 14 in the respective housings determines the minimum detectable object size. A smaller object between two light beams can and should remain undetected because it can be assumed that such a small object is permitted to enter or cross the monitored region 20. When sensor 10 is used to secure a dangerous zone, the spacing between the light emitters and light receivers is selected to fit the particular situation. For protection against incursions by persons, for example, the selected distance will be smaller than the smallest body part that might enter the monitored region.

Light emitter 18 may for example be a semiconductor light source such as an LED or laser diode. They emit light of a narrow band width, and light receivers 14 as well as a downstream evaluation unit can distinguish the light from surrounding and interfering light. The light can have a wave length in the visible, infrared or ultraviolet light range. Emitter housing 16 and all light emitters 18 are coupled to a supply and control unit 22 so that the light emitter 18 can be turned on and off or an identity pattern can be generated for superimposing a signal code onto the emitted light. Such signal codes are used to recognize the individual light emitters during the evaluation of the received light.

Each light receiver 14 is an actual light receiver or a receiving chip 24 and has an associated receiving optics 26. The receiving chip 24 can be a conventional photodiode, but it is presently preferred to use a position resolving PSD (position sensing diode) or a chip that has individual receiving pixels such as a CCD chip or a CMOS chip. The receiving pixels can be arranged in lines or in a two-dimensional matrix.

An evaluation unit 28 is arranged in receiver housing 12 and is coupled to the light receivers 14 thereof. The evaluation unit is operatively connected to a supply and control unit 22 of the emitter housing 14. This connection can then be used to electronically and/or optically synchronize light emitters 18 and light receivers 14. Alternatively, a direct connection can be omitted and synchronization can be attained optically only. In that event, the above referred to signal codes can be used to identify each light emitter 18, which, for example, sequentially emit light in accordance with the signal code. This can be learned by the evaluation unit during a learning phase by multiplexing.

The light emitters 18 direct their light 30 over a large angular range 32, without focusing, and only roughly in the direction of the light receivers 14. As a result, light emitter 18 does not require an aperture stop or emitting optics. An emitting optics can be used to bundle the light for a greater range. However, the emitting optics is not there to prevent retro-reflections and need therefore not be accurately focused. Due to its large angular emitting angle 32, the alignment of light emitter 18 is simple and convenient. In reality, and contrary to the necessarily two-dimensional side elevational illustration of FIG. 1, angular range 32 is a spatial angle and light emitter 18 fills a space with light that defines an emitted light cone. Since the emitted light cone has a large opening angle, the associated light receiver 18 is typically within the emitted light cone even to start with, or after an only simple, rough alignment.

Light receiver 14, on the other hand, only receives light which is inside a received light cone 34 with an opening angle 36. The opening angle is small and at most half as large as a normed opening angle 38. Light receiver 14 must be positioned exactly opposite from light emitter 18 so that the light emitter is within the received light cone 34. Opening angle 36 can be adjusted with aperture stops and/or receiving optics 26. Using a position resolving receiving chip 24 in accordance with the invention greatly simplifies setting the receiving aperture angle and also makes alignment much easier, as is further discussed below in conjunction with FIGS. 3 and 4.

To facilitate the understanding of the conditions which opening angle 36 of the received light cone must fulfill, an emitted light cone 40 and a received light cone 42, both arranged in accordance with the prior art, are shown in FIG. 1 in phantom lines. Both cones 40, 42 satisfy the normed conditions that the opening angles are at most equal to normed angle 38. Meeting the alignment condition involves two steps. As is true both for the present invention and the prior art, light emitter 18 must be positioned in the received light cone of light receiver 14. However, in addition, the norms and prior art require that light receiver 14 must also lie within emitted light cone 40. This second condition of the prior art is automatically met by the present invention because of the large size of the emitted light cone angle 32.

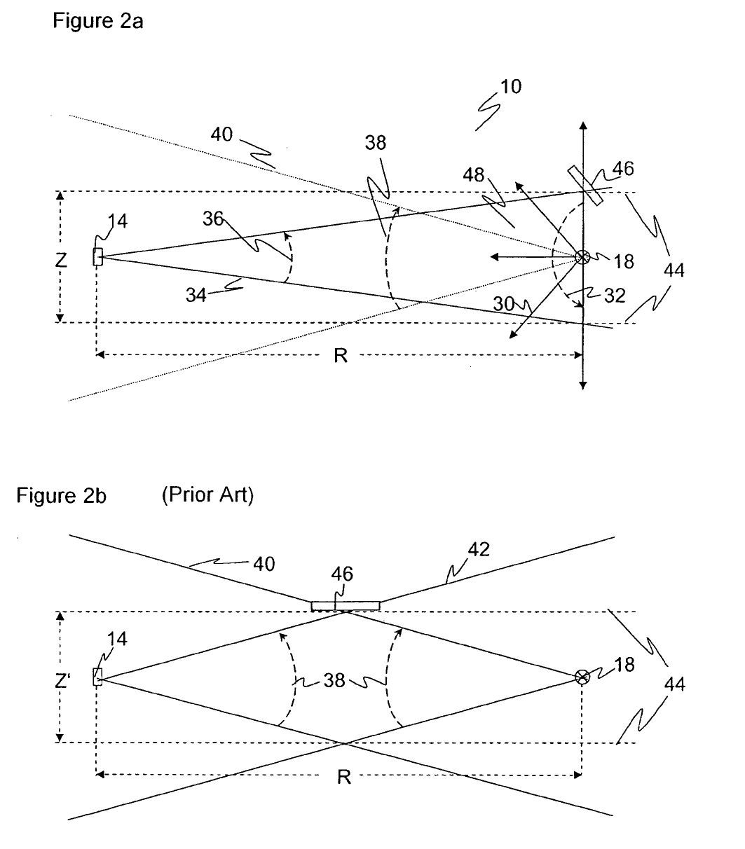

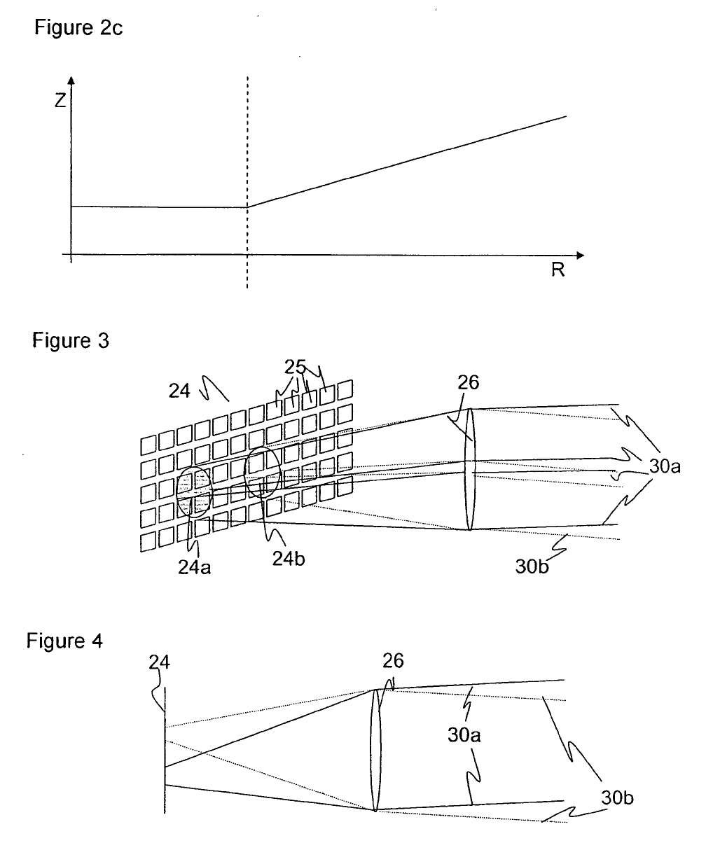

In the prior art the small emitted and received light cones 40, 42 prevent retro-reflections from reaching the light receivers. The present invention satisfies the normed requirements on only one side of the sensor by setting the conditions for received light cone 34, as is further explained with reference to FIGS. 2a and 2b. In the following, the same reference numerals refer to the same elements.

FIG. 2a is a plan view of a single pair formed by a light emitter 18 and a light receiver 14. The emitted light opening angle 32 is 180°, which is a worst case scenario with regard to retro-reflections. An even larger emitted opening angle 32 provides no further advantages and is typically not attainable because of the manner in which the light emitter is mounted and/or obstructions from the housing in which the emitter is installed. Since this worst case satisfies the normed conditions against retro-reflections, it applies even more so for all other possible scenarios.

Safety norms or standards, especially the EEC 61496-2 norm, define how retro-reflections from reflecting surfaces which have a predetermined minimum distance to sensor 10 are prevented. Retro-reflection, as used herein, refers to light from light emitter 18 that reaches light receiver 14 via reflection by one or more reflecting surfaces, and not directly. In reality, the direct path from light emitter 18 to light receiver 14 might be blocked by an object in monitored region 20. Such an object would not be detected by evaluation unit 28 when light reaches light receiver 14 indirectly via retro-reflections and constitutes a sensor malfunction that must be prevented since the health and safety of persons may depend on it.

The safety standard or norm is therefore only satisfied when there is no position or orientation where one or more reflecting surfaces with a minimum distance to sensor 10 can cause retro-reflections. This minimum distance therefore defines a normed region 44 as a “tunnel” or cylinder about a connecting axis between light emitter 18 and light receiver 14 which, as shown in FIG. 2a by phantom lines, are spaced apart by a distance Z. Within normed region 44, retro-reflections can be accepted because they are caused by small reflecting objects that will normally be below the resolution of the sensor as determined by the distance between adjacent light receivers 14. The minimum distance Z defined by the norm is not constant, but depends on the spacing R between light emitters 18 and light receivers 14.

The diameter Z of the space outside of which retro-reflections are not permitted can be determined by locating a reflecting surface 46 at the most undesirable position. As can be seen from FIG. 2a, a surface at a greater distance from Z than the illustrated surface 46 may not reflect light into receiving line cone 34. Accordingly, if α is the size of receiving opening angle 36, the norm requiring Z=2R tan(α/2) is fulfilled.

FIG. 2a shows in phantom lines an emitted light cone 40 that conforms to the prior art and ensures that even in the cross-hatched area 48 no retro-reflections are possible because no emitted light is present in this area. The standard nevertheless requires a cylindrical normed space 44 so that this difference is inconsequential: The additional prevention of retro-reflections in space 48 is of only theoretical value because in reality it provides no advantages and is therefore not required by the standard.

For comparison purposes, FIG. 2b shows a sensor 10 made in accordance with the prior art which has an emitted light cone 40 and a received light cone 42, both of which have an opening angle that corresponds to the normed opening angle 38. As can be seen in FIG. 2b, the retro-reflecting surface 46 that is furthest from the axis connecting light emitter 18 and light receiver 14 is located at the mid-point between the light emitter and the light receiver. Normed space 44 is a cylinder having a diameter Z′ with an outer surface that is parallel to the connecting axis and intersects the circular cross-sections of the emitted light cone and the received light cone.

If the normed opening angle 38 is β, the arrangement shown in FIG. 2b leads to the equation Z′=2 R/2 tan(β/2). If, in accordance with the invention, α=β/2, then β/2=α/2+α/2 and therewith Z′=R tan(β/2)=R tan(α/2+α/2)=R [2 tan(α/2)/(1+tan²(α/2))]≈2R tan(α/2)=Z.

The approximation of the second-to-last step is justified because α is small and tan²(α/2) is negligible relative to 1. When in doubt, the receiving opening angle 36 can be made smaller than one-half the normed opening angle 38. Thus, Z determined in accordance with the invention and Z′ established in accordance with the known normed space 44 are the same. In view thereof, the present invention conforms to the requirements of the standards by simply setting only the opening angle for light receiver 14 or its receiving optics and/or aperture stops.

FIG. 2c schematically illustrates the relationship between normed distance Z and the spacing R between light emitter 18 and light receiver 14. In close proximity, which ends at the vertical phantom line in FIG. 2c, a constant distance Z is given due to the finite width of the light spot which, in the distant region, is coupled to an angle. According to IEC 61496-2, the close proximity ends at a distance R of 3 m, which requires a constant distance of 262 mm for Z (Type 4). The succeeding increase has an angle of 2.5°. From this, Z can be calculated for the distant region as Z=2R tan(2.5°). It should be understood that all numerical values are exemplary. In actual use, the applicable standards are to be maintained, but the numerical values are established based on evaluation and not due to technical requirements. Accordingly, the present invention is not limited to the stated numerical values.

It should be noted that FIGS. 2a and 2b show an ideal case in which the light cone is symmetrical to the connecting axis between light emitter 18 and light receiver 14. Such an orientation cannot be guaranteed because the alignment criterion is whether light can be received so that tolerances up to α (or β according to the prior art) are permitted. In such a case, the normed space 44 is simply parallel repositioned without a change in its size. Such deviations from the symmetry are also encountered in the prior art; the above-discussed considerations can analogously be used with non-symmetric arrangements, which demonstrates that the present invention is as accurate as prior art sensors with emitting and receiving aperture angles that conform to the normed aperture angle 38.

Referring to FIGS. 3 and 4, an alignment of light receiver 14 becomes significantly simplified when a position resolving receiving chip 24 is used. FIG. 3 shows in a perspective view receiving chip 24 defined by a matrix (two-dimensional) of individual light receiving elements 25 or pixels. Emitted light 30a from light emitter 18 is shown in solid lines, and receiving optics 26 focuses light from the emitter as a light spot 24a on receiving chip 24. Light 30b from light emitter 18 is shown in phantom lines also and strikes the receiving chip but it comes from a different direction and generates a light spot 24b. FIG. 4 shows the same in plan view that more clearly shows the direction of the light.

To properly align sensor 10 during a learning phase, light emitter 18 is activated to determine where its light 30a strikes receiving chip 24, that is, which light receiving elements 25 are covered by light spot 24a. Evaluation unit 28 stores the position or identity of the illuminated light receiving elements as the desired position for the light spot during normal operation. It is therefore sufficient to align sensor 10 so that light spot 24a strikes light receiving chip 24 anywhere over its surface. Manufacturing costs primarily limit the size of receiving chip 24. A larger and more highly resolving matrix of receiving elements or pixels 25 is more expensive, but makes alignments more simple and accurate. Thus, the selection, whether a matrix of 16×16, 128×128 or more pixels should be used, is principally dictated by cost considerations.

In use, evaluation unit 28 assumes that there is an uninterrupted direct light path between light emitter 18 and light receiver 14 if those pixels are struck by emitted light 30a which are at the previously learned desired positions. The other pixels 25 are here effectively unused. Nevertheless, the received light can still be made use of, for example to obtain information concerning interfering light. When emitted light 30b is received from a different direction, it will not strike the desired position defined by the learned-in pixels or light receivers beneath light spot 24a, but other light receiving elements or pixels 25 at another position 24b. Evaluation unit 28 therefore receives information from light emitters which are not at the expected, learned-in desired position. This is processed by evaluation unit 28 like an interrupted light beam. There are only two reasons for the received light beam to strike a position other than the desired position on receiving chip 24, both of which must be recognized by sensor 10: Sensor 10 is either out of alignment or the emitted light 30 was not received by light receiver 14 directly, but along an indirect light path following a retro-reflection of the light.

The position resolving light receiver 14 significantly simplifies making alignments. The desired position, the size and position accuracy of which depends on the resolution capability of matrix 24 or the quality of optics 26, ultimately determines the receiving aperture angle 36. For this reason, half the required normed aperture angle 38 can be set in a simple alignment process. The learning-in of the desired position provides the option of not using a mechanical aperture stop at the receiving side.

FIG. 5 shows another embodiment of the invention in which light emitter 18 is not mounted in a rigid housing 16, but on a flexible carrier 50. Light emitters 18 thereby define a flexible carrier, such as a light hose or conduit, which can be conformed to any desired contour. As a result, light emitters 18 need not be applied to flat surfaces only and can extend along bends and curves and/or can be integrated in machines and equipment that needs securing. Light emitters are preferably electrically coupled in series so that the flexible carrier 50 can be cut off (shortened) at one end. At the other end of flexible carrier 50, light emitters 18 are coupled to the supply and control unit 22.

Flexible carrier 50 and its control 22 can be optically synchronized on the receiving side with evaluation unit 28. Since the emitted opening angle 32 can be of virtually any size, the light hose can be mounted at the other side of the monitored region with no or only minor adjustments. There the light hose is independent of its supply and control unit 22. A flexible carrier 15 cannot be used with conventional sensors because the light emitters with their small emitted light cone might not reach the opposite light receiver 14. The advantage provided by the flexibility of the hose is therefore lost because at each location where a light emitter 18 is located, an at least approximate parallel orientation of the light is required.

In a further embodiment of the invention, light receivers 14 can also be arranged on a flexible carrier. In such a case, at least the receiving optics 26 must be rigidly connected to the associated receiving chip 24. Once the flexible carrier with light receivers 14 is installed, the respective desired positions can be learned-in during the learning phase, and their proper adjustment is assured by sequentially directing the light to the individual light emitters 18/light receivers 14. Contrary to the case when flexible carrier 50 has only light emitters 18, a flexible carrier with light receivers 14 cannot be placed anywhere because the light from the emitters must be directed onto receiving chip 24 via receiving optics 26. However, the position resolving light receiver 14 nevertheless provides at least a fairly large angle within which the flexible carrier can be mounted.

It should be noted that in a light grid of light emitters 18 and light receivers 14, the spacing between the emitters and receivers can be as tight as one in which the flexible carrier is straight. By appropriate connection, the distance between light emitters 18 and light receivers 14 can at most be reduced, it can never be enlarged. The spacing between light emitters 18 or light receivers 14 can be changed by changing electrical connections, but the distance can at most be reduced, it can never be enlarged. In this way, the resolution of the flexible carrier defined by the spacings of the light emitters and/or light receivers on the flexible carrier is attained, if not improved. The resulting protective field, which no longer is only a function of the housing size and, due to the flexibility of the hose, can take a not necessarily discernible shape, must be checked with a checking wand. When in doubt, a somewhat longer flexible carrier with several additional light emitters 18 and/or light receivers 14 should be selected. It can later on be shortened according to the required protective field size.

The flexible light hoses permit an integration of sensor 10 on a component basis on machines or machinery parts. It is not necessary to acquire and install a fixed and prefabricated light grid, because the sensor of the present invention can be flexibly integrated into the machine or machine part while its installation remains simple and the safety and accuracy of the present invention continue to be available.

What is claimed is:

1. An optoelectronic sensor for detecting an object in a monitored region comprising
at least one light emitter and at least one associated light receiver adjustably arranged relative to each other so that light emitted by the light emitter is directly received by the light receiver,
the light emitter and the light receiver conforming to a normed condition which defines a normed region that is free of reflecting surfaces so that light emitted by the light emitter which passed beyond the normed region cannot be received by the light receiver due to a reflection of the light,
wherein the normed region includes an overlap of an emitted light cone generated by the light emitter and a received light cone defined by the light receiver is within a normed opening angle,
an evaluation unit which interprets an interruption in the light directed to the light receiving element as a detection of an object in the monitored region,
the light emitter forming an emitted light cone with an opening angle of any desired magnitude, and
the light receiver being configured to limit an opening angle of the received light cone to no more than one-half of the normed opening angle.

2. An optoelectronic sensor according to claim 1 wherein the emitted light cone angle is greater than the normed opening angle.

3. An optoelectronic sensor according to claim 1 including a receiving optics adapted to limit the opening angle of the received light cone to no more than one-half the normed opening.

4. An optoelectronic sensor according to claim 1 wherein the at least one light receiver is a position resolving light receiver, and wherein the evaluation unit is adapted to determine a predetermined position on the at least one light receiver for receiving the light and to determine a detection of received light outside the predetermined light receiving position as a detection of an object.

5. An optoelectronic sensor according to claim 1 including optics associated with the at least one light emitter for reducing an emitted light cone angle to thereby enlarge the range of the sensor.

6. An optoelectronic sensor according to claim 1 including a flexible carrier and a multiplicity of light receivers arranged on the carrier.

7. An optoelectronic sensor according to claim 6 wherein the flexible carrier comprises a hose.

8. An optoelectronic sensor according to claim 1 including a flexible carrier and a multiplicity of light receivers arranged on the carrier, and wherein each receiving optics is fixedly connected relative to the associated light receiver.

9. An optoelectronic sensor according to claim 8 wherein the flexible carrier comprises a hose.

10. An optoelectronic sensor according to claim 6 wherein the flexible carrier and the evaluation unit are configured to permit separation of at least one light receiver and at least one light emitter without affecting the functionality of non-separated light receivers and light emitters.

11. An optoelectronic sensor according to claim 1 wherein at least one of the light emitter and the light receiver are electrically connected in series.

12. An optoelectronic sensor according to claim 1 wherein the sensor comprises one of a light barrier and a light grid.

13. An optoelectronic sensor according to claim 12 including first and second housings and a multiplicity of light emitters and light receivers arranged in the housings so that the light emitters are opposite associated light receivers during use of the sensor.

14. An optoelectronic sensor according to claim 1 wherein the at least one light emitter includes its own control unit and current supply which is configured to optically synchronize itself with the evaluation unit of the light receiver.

15. An optoelectronic sensor according to claim 1 wherein the at least one light emitter and the at least one light receiver are coupled to an evaluation unit and a common current supply, and wherein the evaluation unit is configured to at least one of optically and electrically synchronizing the light emitter and the light receiver.

16. A method for detecting an object in a monitored region comprising
providing at least one light emitter and at least one light receiver associated with the at least one light emitter,
arranging the light emitter and the light receiver relative to each other so that light from the light emitter is directly received by the light receiver,
forming a normed region in conformity with normed standard conditions requiring the normed region to be free of reflecting surfaces, the normed region being arranged to prevent light that has traveled past the normed region from being received by the light receiver following a reflection of the light that has traveled past the normed region,
wherein an overlap of an emitted light cone from the at least one light emitter and a received light cone defined by the at least one light receiver is included in a normed opening angle,
interpreting an interruption of light received by the light receiver as a detection of an object,
operating the sensor in accordance with normed standard conditions by emitting light from the light emitter along an emitted light cone of any desired angle, and
with the light receiver, only receiving light within the received light cone having an opening angle that is no greater than one-half the normed opening angle.

17. A method according to claim 16 including selecting an opening angle that is greater than a size of the normed opening angle.

18. A method according to claim 16 wherein the light receiver is a position resolving light receiver, and including determining a desired light receiving position on the light receiver and deciding that an object has been detected when light is received outside the desired light receiving position.

19. A method according to claim 16 including increasing an operating range by reducing the emitted light cone angle.

20. A method according to claim 16 including arranging at least one light emitter and at least one light receiver along a curve.
